(19) United States
(12) Patent Application Publication
(10) Pub. No.: US 2013/0177086 A1
(43) Pub. Date: Jul. 11, 2013

(54) FINE MOTION ESTIMATION DEVICE FOR HIGH RESOLUTION

(71) Applicant: Electronics and Telecommunications Research Institute, Daejeon (KR)

(72) Inventors: Seong Mo Park, Daejeon (KR); Young-il Kim, Daejeon (KR); Nak Woong Eum, Daejeon (KR); Hee-Bum Jung, Daejeon (KR)

(73) Assignee: Electronics and Telecommunications Research Institute, Daejeon (KR)

(21) Appl. No.: 13/738,638

(22) Filed: Jan. 10, 2013

(30) Foreign Application Priority Data
Jan. 11, 2012 (KR) 10-2012-0003443

(51) Int. Cl. H04N 7/26

(52) U.S. Cl. CPC H04N 19/0063
USPC 375/240.17

(57) ABSTRACT

Disclosed is a fine motion estimation device for high resolution including: a previous picture storage memory in which search area data of previous pictures for macroblocks of current pictures are stored; an FIR filter configured to perform FIR filtering on the search area data stored in the previous picture storage memory; a memory configured to differentiate and store the FIR filtered search area data; a QME data processing unit configured to generate reference area data for motion estimation in a ¼ pixel unit; a processing array unit configured to perform motion estimation in a ½ pixel unit and the macroblocks transmitted from the FIR filter and motion estimation in the ¼ pixel unit; and a control unit configured to control operations of the FIR filter, the processing array unit, and the QME data processing unit.

### CROSS-REFERENCES TO RELATED APPLICATIONS

The present application claims priority under 35 U.S.C 119(a) to Korean Application No. 10-2012-0003443, filed on Jan. 11, 2012, in the Korean Intellectual Property Office, which is incorporated herein by reference in its entirety set forth in full.

### BACKGROUND

Exemplary embodiments of the present invention relate to a design field of a system on a chip (SoC) for implementing a compression algorithm of picture data in hardware, and more particularly, to a fine motion estimation device for high resolution capable of estimating motion using minimum hardware by a fine motion estimation method of a motion estimation block having the most calculations among component blocks of H.264.

H.264 is a standard that has been jointly developed by VCEG of ITU and MPEG of ISO that are an international moving picture standard establishment group. The standard relates to an implementation of a very high compression rate as a main technical target and is a general-purpose moving picture encoding technology that may be used in environment of almost all transmission media and various moving picture resolutions such as a storage medium, the Internet, satellite broadcasting, and the like.

Typically, the International standard of ITU establishes the moving picture encoding standard such as H.261, H.263, H.264, and the like, based on a wired communication medium and the MPEG has established MPEG-1, MPEG-2, and the like, for processing moving pictures in the storage medium or the broadcast medium as a standard. The MPEG has also established an MPEG-4 moving picture standard realizing various functions and a high compression rate that considers object based moving picture coding in the MPEG-4 that is a coding standard over multimedia as important features. The VCEG group of ITU has continuously established the moving picture standard of the high compression rate under the name of H.26L even after the MPEG-4 moving picture standard has been established and in the formal comparison experiment of the MPEG, exhibits superiority larger in terms of the compression rate, as compared with the MPEG-4 moving picture standard (advanced simple profile) having a similar function. Therefore, the MPEG has developed the H.264/AVC that is a JVT moving picture standard together with the ITU VCEG group using the H.26L. The H.264/AVC having a history described above has various excellent characteristics.

At the time of implementing the SoC using the H.264 that is the multimedia moving picture compression standard, the block having the most calculations in the encoder is just a motion estimation block. In particular, the motion estimation has the high correlation between the neighboring screens of the video signal. The compression efficiency of the video signal may be increased by reducing the redundant information that is present on the time base. The motion estimation requires a lot of calculations. So far, many algorithms and hardware architectures have been researched.

Korean Patent Laid-Open Publication No. 2008-0005146 disclosed a motion estimation method using a high-speed full search block matching algorithm capable of improving a processing speed while reducing calculations at the time of implementing an SoC using the motion estimation algorithm in accordance with the related art. Korean Patent Laid-Open Publication No. 2008-0005146 uses a method of calculating SADs in order from a pixel having the lowest frequency among pixel values of the current macroblocks and determining early termination, but has a limitation in calculating the optimal SADs and motion vectors using selection according to coding modes when intending to access a reference picture.

In addition, US Patent Laid-Open Publication No. 2010/0091863 disclosed a motion estimation method having reused architecture for rapidly searching predicted data.

FIG. 1 is a flow chart of a motion estimation method having architecture of reusing predicted data in accordance with the related art.

First, motion data of current blocks of coding data are searched (S110).

When searching the motion data, a rapid prediction plane is set corresponding to strong spatial correlation of motion vectors of three blocks neighboring to the current blocks (S120).

Here, three neighboring blocks are a left block, a top block, and a top left block. According to the rapid prediction plane, a rapid motion estimation method predicts the motion vectors of the current blocks within a search range and then, predicts search paths of the current blocks within the search range.

Next, an optimal matching algorithm such as a diamond search algorithm is selected by rapidly searching BMA data. The diamond search algorithm includes four points (left, right, top, and bottom points) that are in the same distance from a targeted point.

Thereafter, the search paths of each current block within the search range are predicted for rapid search BMA data (S140), wherein the BMA data are calculated for acquiring the optimal matching block and the motion vectors of the current blocks for the optimally matched reference block are acquired. According to the motion estimation method using the prediction plane, hardware may be additionally required and thus, power consumption may be increased due to the additionally used hardware.

A background art of the present invention is disclosed in ‘Low-Power And High-Throughput Design Of Fast Motion Estimation VLSI Architecture For Multimedia System-On-Chip Design’ of US Patent Laid-Open Publication 2010/0091863 (Jul. 18, 2010).

The above-mentioned technical configuration is a background art for helping understanding of the present invention and does not mean related arts well known in a technical field to which the present invention pertains.

### SUMMARY

An embodiment of the present invention is directed to a fine motion estimation device capable of reducing a hardware area without degrading performance by configuring architecture in which various modes can be processed in parallel and implementing the various modes using a single hardware, in a fine motion estimation method for a motion estimation block having the most calculations among component blocks of H.264.

An embodiment of the present invention relates to a fine motion estimation device for high resolution in accordance with an embodiment of the present invention including: a current picture storage memory in which macroblocks of current pictures that are a motion estimation object are stored; a previous picture storage memory in which search area data of previous pictures for macroblocks of current pictures are stored; an FIR filter configured to perform FIR filtering on the search area data stored in the previous picture storage memory; a memory configured to differentiate and store the FIR filtered search area data; a QME data processing unit configured to generate reference area data for motion estimation in a ¼ pixel unit; a processing array unit configured to perform motion estimation in a ½ pixel unit and the macroblocks transmitted from the FIR filter and motion estimation in the ¼ pixel unit; and a control unit configured to control operations of the FIR filter, the processing array unit, and the QME data processing unit.

The processing array unit may search the ½ pixel motion vector and the ¼ pixel motion vector according to the motion estimation in the ¼ pixel unit by calculating sum of absolute differences (SADs).

The processing array unit may include: nine processing elements configured to calculate SAD values with one of the current picture macroblock data, the reference picture data, and the search area data; and an SAD determining unit configured to output a minimum value among the SAD valued output from the plurality of processing elements and positions corresponding thereto.

The FIR filter may include: a horizontal filtering unit configured to perform 6-tab FIR filtering in a horizontal direction on the search picture data; a first vertical filtering unit configured to perform the 6-tab FIR filtering in a vertical direction on a first output value having a 64 bit size of the horizontal filtering unit when a motion in a horizontal direction is integer component; a second vertical filtering unit configured to perform the 6-tab FIR filtering in a vertical direction on a second output value having a 120 bit size of the horizontal filtering unit when a motion in a horizontal direction is ½ pixel component; and a data arrangement logics configured to perform data arrangement on an output value of the first vertical filtering unit and an output value of the second vertical filtering unit.

The fine motion estimation device may further include: a data synchronization unit configured to synchronize the macroblocks of the current pictures with the FIR filtered search area data.

When the macroblocks of the current pictures are 16×16, a size of the search area of the previous pictures may be 64×48.

The operating modes may be at least one of a 16×16 mode, a 16×8 mode, a 8×16 mode, and a 8×8 mode.

The memory may be configured of four SRAMs having parallel architecture.

The QME data processing unit may be a motion estimation processing unit in the ¼ pixel unit that processes data for motion estimation in the ¼ pixel unit.

### BRIEF DESCRIPTION OF THE DRAWINGS

The above and other aspects, features and other advantages will be more clearly understood from the following detailed description taken in conjunction with the accompanying drawings, in which:

FIG. 1 is a flow chart of a motion estimation method having architecture of reusing predicted data in accordance with the related art;

FIG. 2 is a configuration block diagram of a fine motion estimation device in accordance with an embodiment of the present invention;

FIG. 3 is a diagram illustrating data architecture of an SRMA shared by an integer-level motion estimation device for motion estimation and motion compensation of luminance component using a previous picture storage memory in accordance with an embodiment of the present invention;

FIG. 4 is a configuration block diagram of a processing array unit of the fine motion estimation device in accordance with an embodiment of the present invention;

FIG. 5 is a diagram illustrating a process of calculating SADs in a single processing element included in the processing array unit;

FIG. 6 is a status diagram of a finite state machine (FSM) in accordance with an embodiment of the present invention;

FIG. 7 is a diagram illustrating an operating mode of an SRAM for each time in accordance with an embodiment of the present invention;

FIG. 8 is a diagram illustrating an internal structure of an FIR filter of the fine motion estimation device in accordance with the embodiment of the present invention; and

FIG. 9 is a diagram illustrating a filter calculating unit of a QME data processing unit in accordance with an embodiment of the present invention.

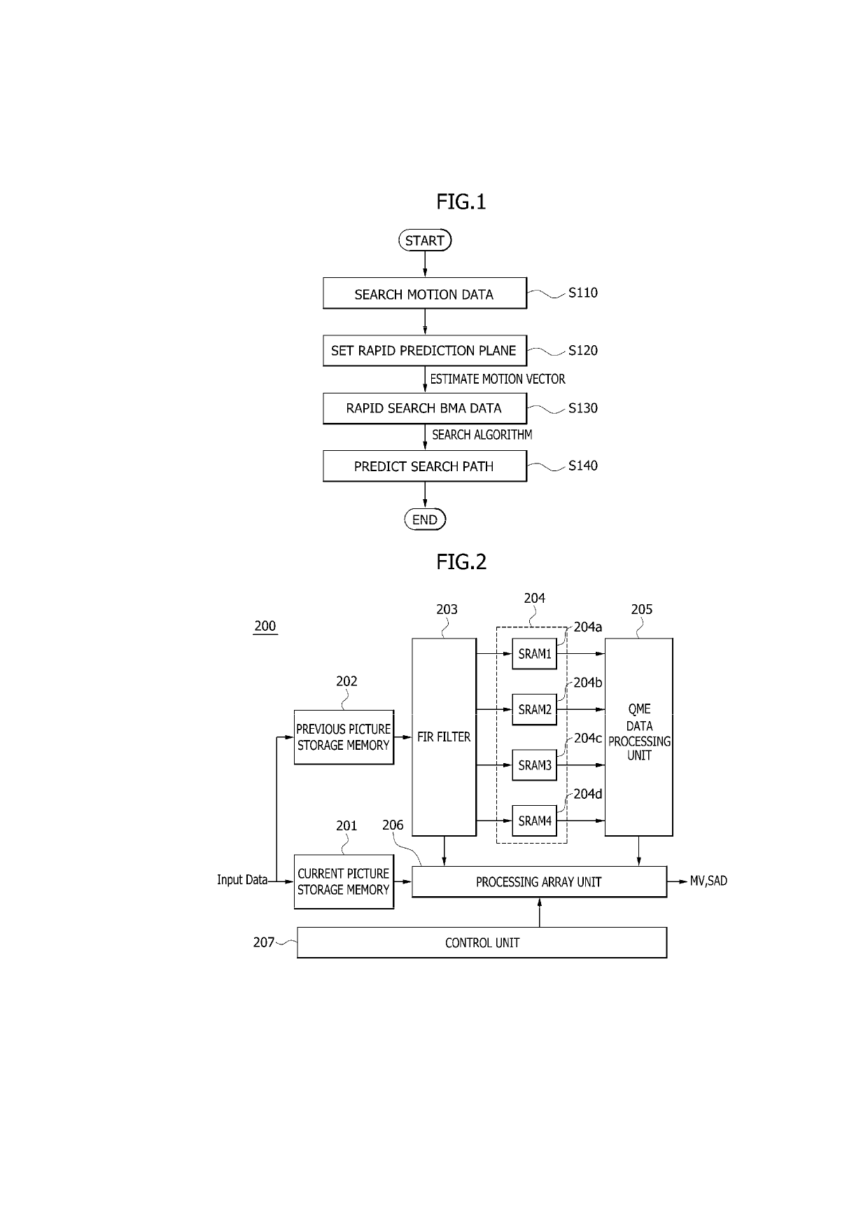

### DESCRIPTION OF SPECIFIC EMBODIMENTS

Hereinafter, a fine motion estimation device for high resolution in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

FIG. 2 is a configuration block diagram of a fine motion estimation device in accordance with an embodiment of the present invention.

Referring to an embodiment of the present invention, a fine motion estimation device 200 includes a current picture storage memory 201, a previous picture storage memory 202, an FIR filter 203, a memory 204, a QME data processing unit 205, a processing array unit 206, and a control unit 207.

A fine motion estimation and motion compensation for SVC (FMEMC) in accordance with an embodiment of the present invention is operated by receiving operating modes, a maximum of four integer-unit motion vectors from an integer-level motion estimation module (IME). Here, for motion estimation and/or compensation in a ¼ pixel unit, required current macroblock data and reference area data may be provided through a 64-bit SRAM disposed between the integer-level motion estimation module and the fine motion estimation and motion compensation for SVC. All the control signals required for operation are input from the outside and the operation in the macroblock unit is completed by generating the motion compensated data and a maximum of four motion vectors for the current macroblocks and then, generating a signal informing that the operation is completed.

A size of the block supported in the fine motion estimation device is at least one of 16×16, 16×8, 8×16, and 8×8 and a ½ pixel and a ¼ pixel is supported by hierarchically estimating motion. In this case, a horizontal/vertical search area is in a range between −0.75 and +0.75.

Referring to FIG. 2, the fine motion estimation device 200 in accordance with the embodiment of the present invention includes the current picture storage memory 201, the previous picture storage memory 202, the FIR filter 203, the memory 204, the QME data processing unit 205, the processing array unit 206, and the control unit 207.

The control unit 207 determines an area to be read from the memory 204 and calculates a memory address therefor.

The fine motion estimation device 200 receives dedicated control signals corresponding to the macroblocks required for operation and initiates two-stage motion estimation based on the motion vectors extracted from the integer-level motion estimation module (IME).

A first stage is the motion estimation in a ½ pixel unit and performs the motion estimation in a range between −0.5 and +0.5 in horizontal and vertical directions, respectively. In the second stage, a final motion vector is estimated with ¼ pixel accuracy based on the motion vector in a ½ pixel unit estimated in the first stage.

Generally, the operation is repeatedly operated according to a block partition mode determined in the integer-level motion estimation module. That is, in the case of the 16×16 mode, the motion estimation and compensation are performed once based on 16×16 macroblock mode data but, in the case of the 8×8 mode, the motion estimation and compensation are repeatedly performed four times based on 8×8 macroblock data.

The data input from the outside are stored in the previous picture storage memory 202 and the current picture storage memory 201. The current picture storage memory 201 stores the input signal regarding the current macroblock data, that is, a current frame for performing the motion estimation and the previous picture storage memory 202 stores search area data, that is, the input signal corresponding to a previous frame of the current frame for performing the motion estimation.

When the search area data are input to the previous picture storage memory 202, the search area data are transmitted to a latter-stage FIR filter 203 and subjected to finite impulse response (FIR) filtering.

The FIR filtered data are stored in four SRAMs 204a to 204d according to a data type and at the same time, sum of absolute differences (SADs) with the current macro blocks are calculated by the processing array unit 206 formed of nine processing elements. The motion vectors in the ½ pixel unit are determined according to the calculated results. The configuration and operation of the processing array unit 206 will be described in more detail with reference to the related drawings.

The QME data processing unit 205 is a ¼ pixel motion estimation processing unit that performs the motion estimation in the ¼ pixel unit. The QME data processing unit 205 generates the reference area data required for the ¼ pixel motion estimation based on the motion vector in the determined ½ pixel unit. For generating the reference area data, the data stored in the SRAMs 204a to 204d in which the FIR filtered data are stored are read. The reference area data are transmitted to the processing array unit 206 and are used to search the motion vectors in the 1.4 pixel unit.

When the motion vectors in the ¼ pixel unit are determined, the QME data processing unit 205 performs the motion compensation based on the determined motion vectors to complete the motion estimation and compensation for luminance component.

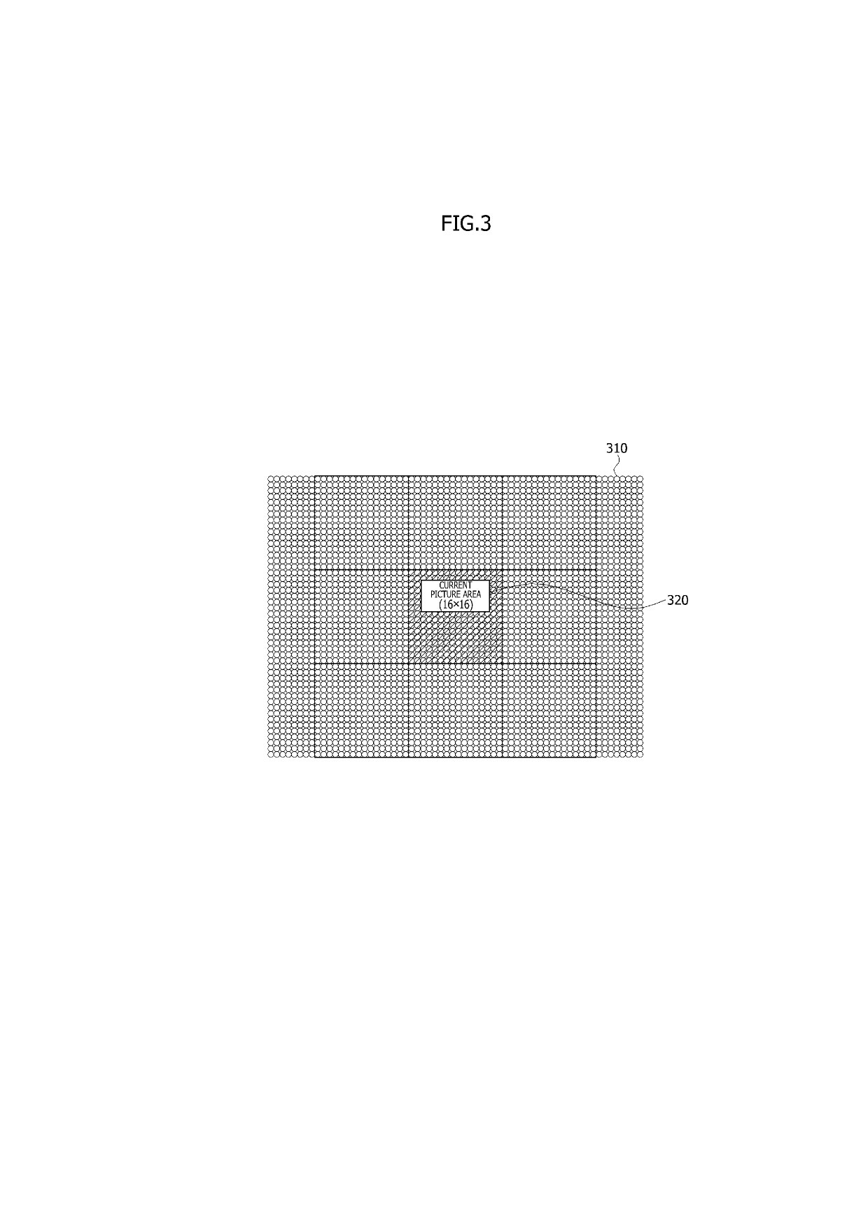

FIG. 3 is a diagram illustrating data architecture of an SRMA shared by an integer-level motion estimation device for motion estimation and motion compensation of luminance component using a previous picture storage memory in accordance with an embodiment of the present invention.

The SRAMs 204a to 204d are configured in a 64 bit word unit and stores the previous picture data corresponding to the search area block of a 64×48 size, that is, a previous picture search area 310 of 64×48 based on the number of pixels. In this case, referring to FIG. 3, a 16×16 square of a central portion indicates an area 320 corresponding to the current macroblocks in the search area.

When considering extra data for performing the two-dimensional FIR filtering performed in the latter-stage FIR filter 203, the range in which the motion estimation is performed in an integer unit is −23 to +23 in a horizontal direction and −15 to +15 in a horizontal direction.

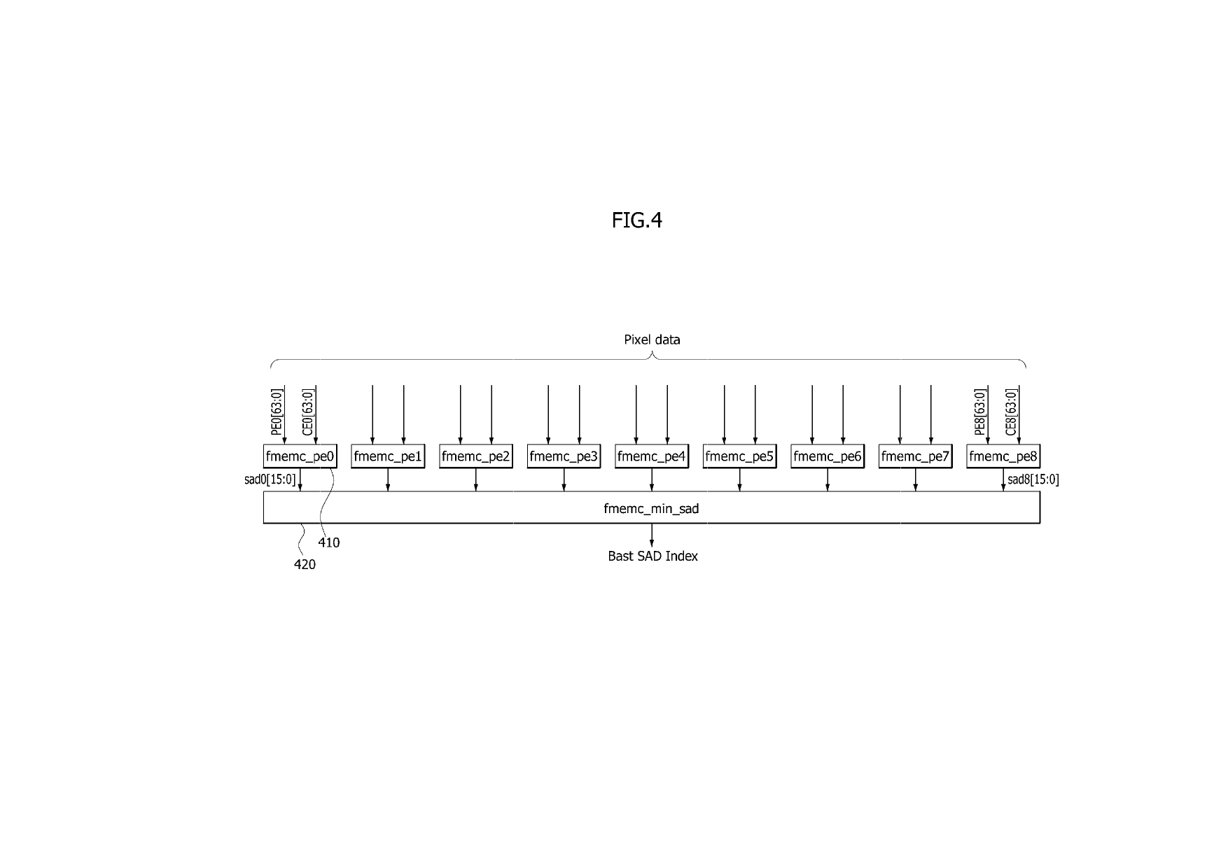

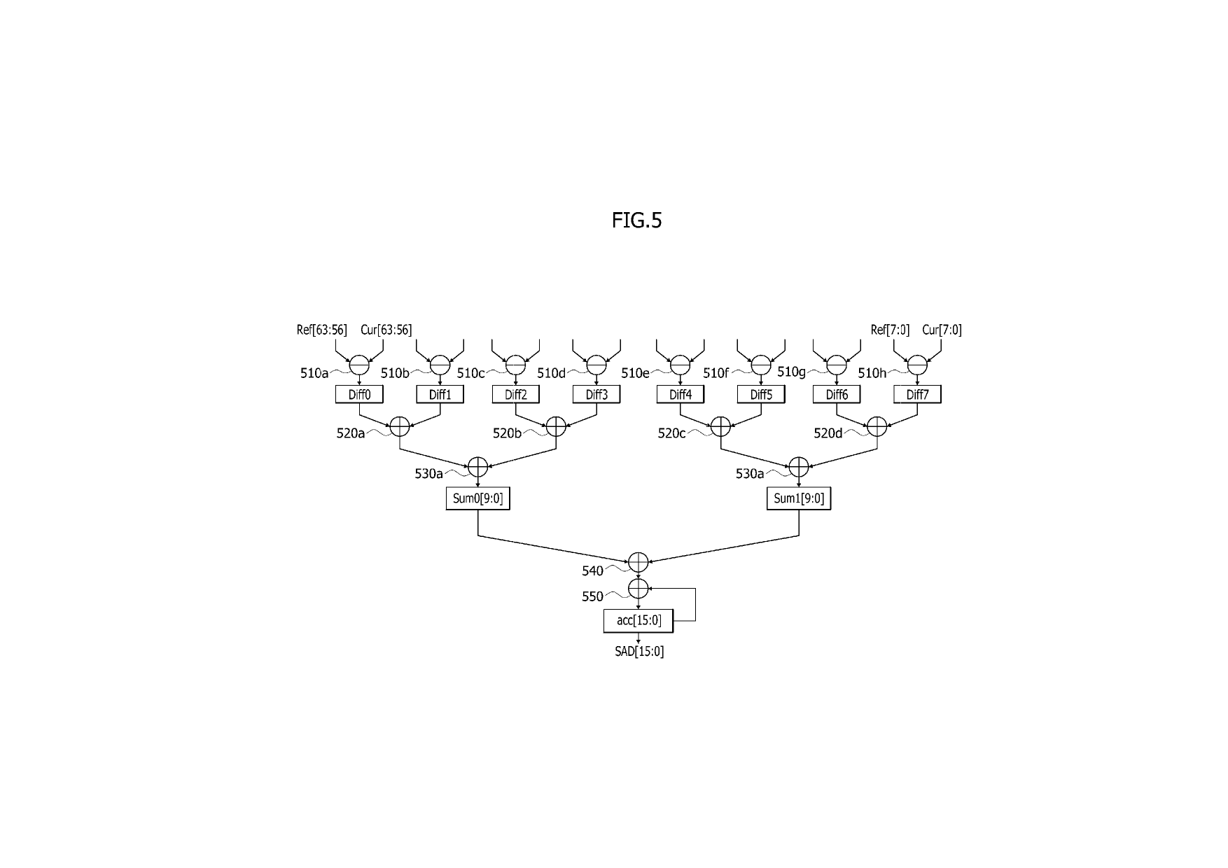

FIG. 4 is a configuration block diagram of a processing array unit of the fine motion estimation device in accordance with an embodiment of the present invention and FIG. 5 is a diagram illustrating a process of calculating SADs in a single processing element included in the processing array unit.

Referring to FIG. 4, the processing array unit 206 includes nine processing elements 410 and an SAD determining unit 420.

The processing elements 410 each receive the current picture macroblock data and the reference picture data (previous picture data) and calculate the SADs. The nine processing elements 410 may be operated independently to simultaneously calculate the nine SADs.

The current picture macroblock data and the reference picture data CEO [63:0] to CE8 [63:0] and PE0 [63:0] to PE8 [63:0] are 64-bit data and are the same as the configuration unit in the above-mentioned SRAMs 204a to 204d. Further, the SAD values calculated in the processing element 410 are 16 bit data.

FIG. 5 illustrates a process of calculating SADs performed in any processing element 410.

The processing element 410 partitions the current picture macroblock data that are 64 bit data and the reference picture data in a 8 bit unit from the most significant bit to the least significant bit and inputs the data corresponding to eight subtractors. For example, Cur [63:56] that is the most significant 8 bit of the current picture macroblock data and Ref [63:56] that is the most significant 8 bit of the reference picture data are input to one subtractor and the difference value thereof is calculated as Diff0.

As such, the difference values calculated in the 8 bit unit are grouped by two in order to perform addition and the results are again grouped by two to perform addition, thereby acquiring a first added value Sum0 [9:0] and a second added value Sum1. [9:0] that are 10 bit data. The addition is performed for the first added value and the second added value, the previous added valued and the accumulated addition are performed acc [15:0], and the 16 bit SAD value SAD [15:0] is output.

Referring again to FIG. 4, the SAD determining unit 420 searches a minimum value among the nine SADs calculated in the nine processing elements 410 and outputs the positions therefor.

In the present embodiment, the processing array unit 206 is also used for the motion estimation in the ½ pixel unit and the motion estimation in the ¼ pixel unit.

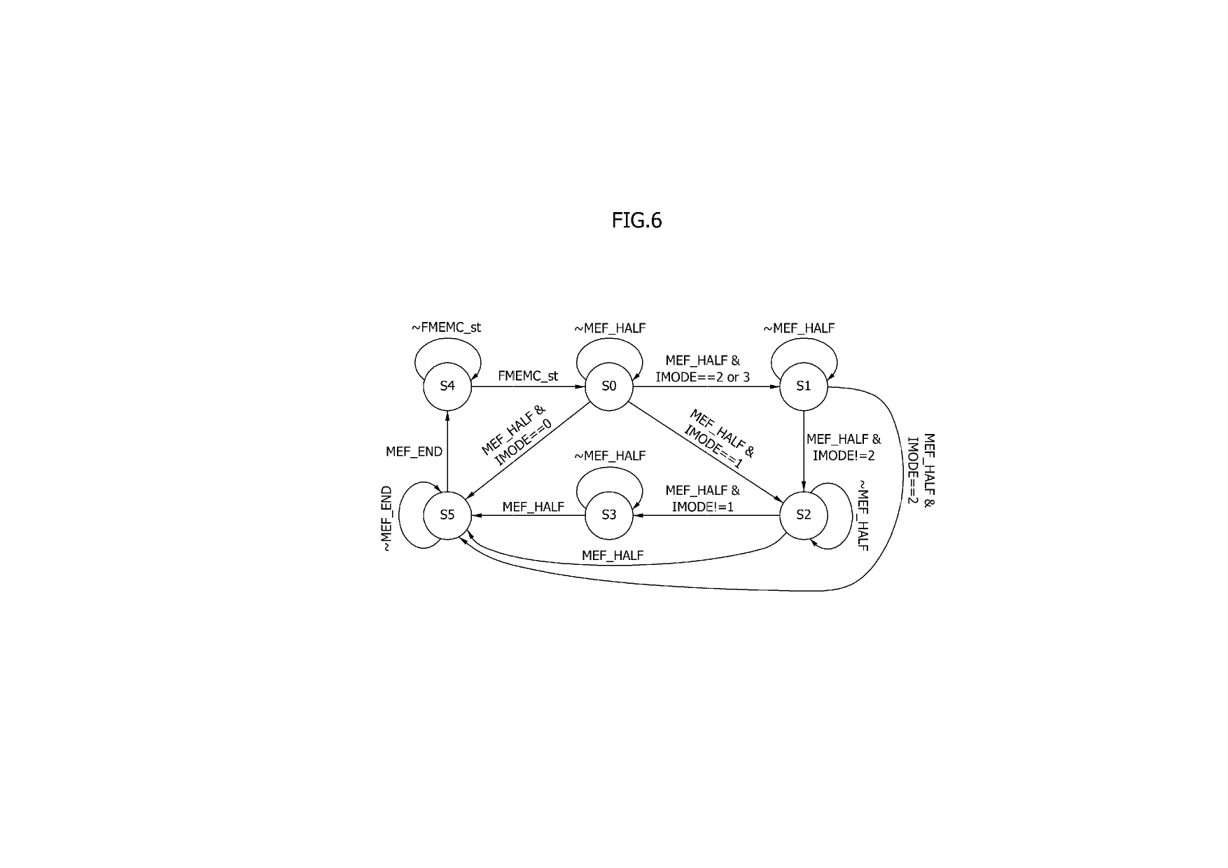

FIG. 6 is a status diagram of a finite state machine (FSM) in accordance with an embodiment of the present invention.

As signals used during a process of shifting a status, FMEMC_st, MEF_HALF, MEF_END, and the like, are used. The FMEMC_st is generated when the operation at the macroblock level starts. The MEF_HALF is generated in the core module and is generated when the motion vector correction for the sub-macroblock is completed. The MEF_END is generated when the motion compensation for the sub-macroblock is completed.

When the operation at the macroblock level starts in status 4 (S4), the FMEMC_st signal is generated and is shifted to status 0 (S0).

In the status 0 (S0), the operation waits until the MEF_HALF signal is generated and if the MEF_HALF signal is generated, the operation is shifted to status 5 (S5) when the IMODE value is 0, shifted to status 2 (S2) when the IMODE value is 1, and shifted to status 1 (S1) when the IMODE value is 2 or 3, according to the IMODE values.

In the status 1 (S1), the operation waits until the MEF_HALF signal is generated and if the MEF_HALF signal is generated, is shifted to the status 5 (S5) when the IMODE value is 2, and shifted to the status 2 (S2) when the IMODE value is not 2.

In the status 2 (S2), the operation waits until the MEF_HALF signal is generated and if the MEF_HALF signal is generated, is shifted to status 3 (S3) when the IMODE value is 1, and otherwise, shifted to the status 5 (S5).

In the status 3 (S3), the operation waits until the MEF_HALF signal is generated, and if the MEF_HALF signal is generated, is shifted to the status 5 (S5).

In the status 5 (S5), the operation waits until the MEF_END signal is generated, and if the MEF_END signal is generated, is shifted to the status 4 (S4).

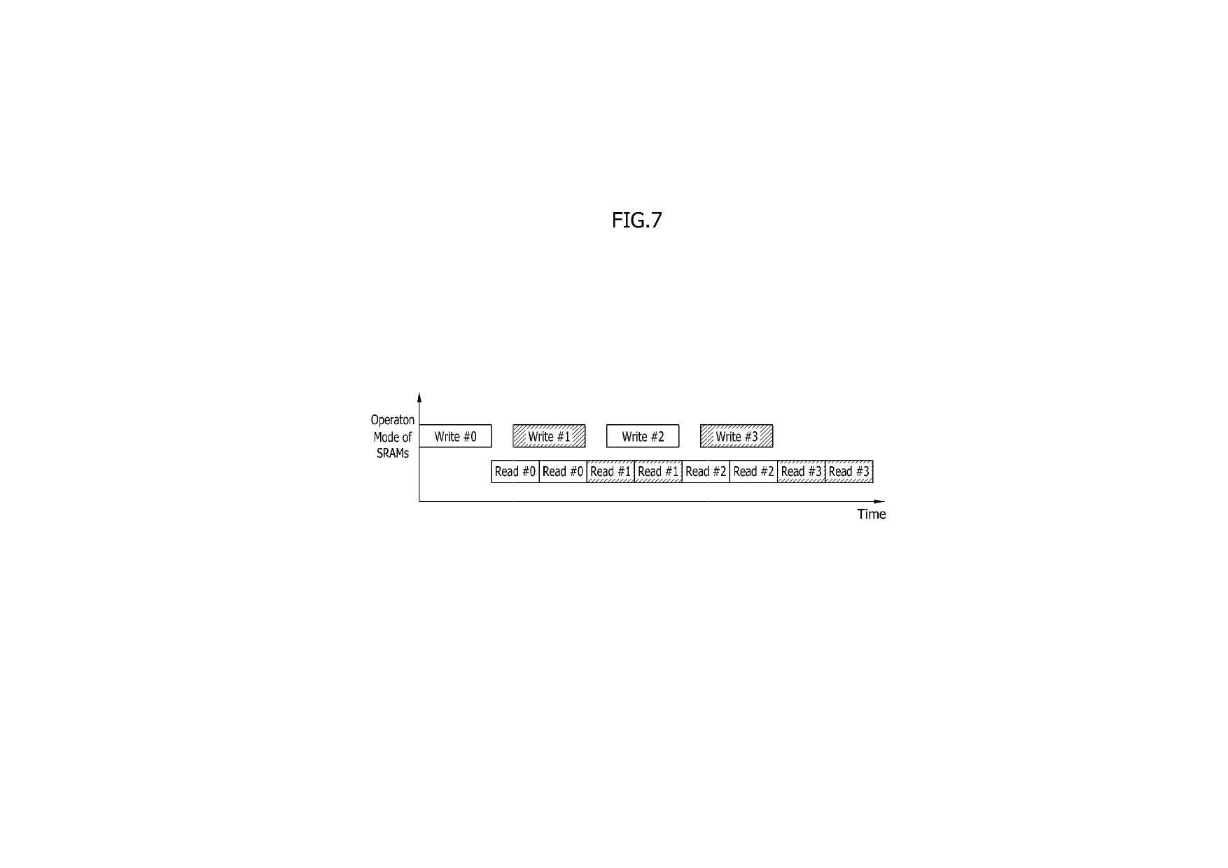

FIG. 7 is a diagram illustrating an operating mode of an SRAM for each time in accordance with an embodiment of the present invention.

The fine motion estimation device in accordance with the embodiment of the present invention includes the SRAM having the parallel architecture.

The case having the parallel architecture increases the costs of the SRAM twice as compared with the case having the sequential architecture but can perform the ½ pixel motion estimation on the next sub-macroblock before the motion compensation for the single sub-macroblock is completed and thus, can remarkably reduce the number of cycles consumed for the motion estimation and/or compensation for the single macroblock.

Referring to FIG. 7, after the writing operation for No. 0 sub-macroblock is performed, the writing operation for No. 1 sub-macroblock may be performed during the reading operation. That is, before the reading operation for No. 0 sub-macroblock is completed, the writing operation for No. 1 sub-macroblock can be performed and thus, the consumed time can be shortened.

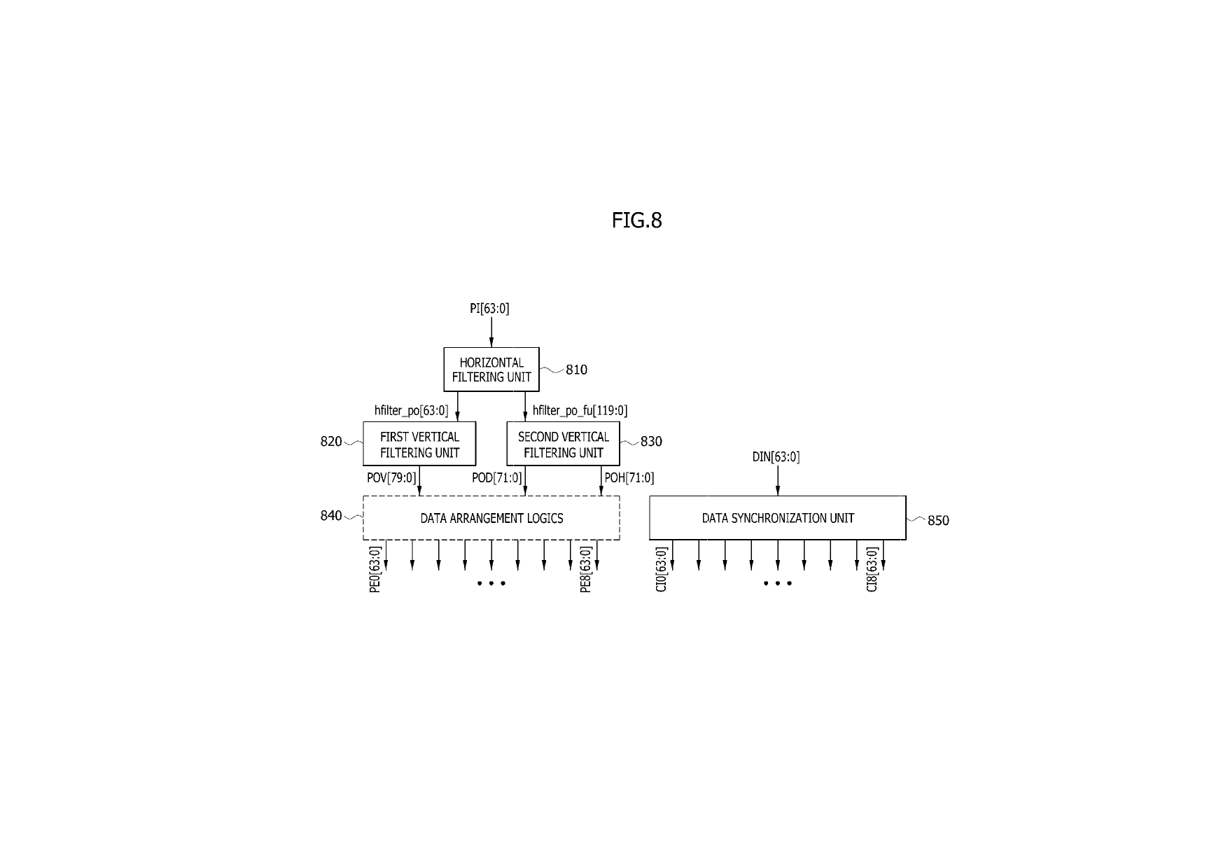

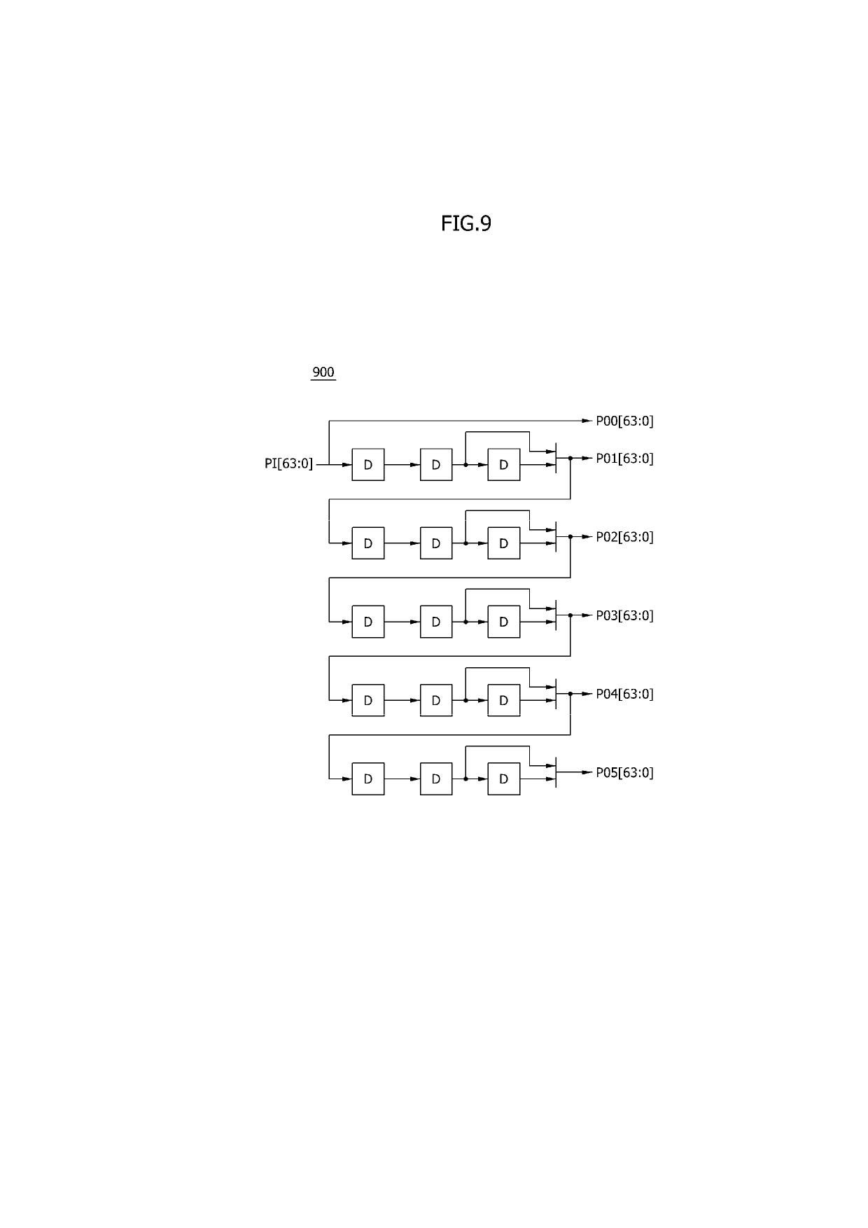

FIG. 8 is a diagram illustrating an internal structure of an FIR filter of the fine motion estimation device in accordance with the embodiment of the present invention and FIG. 9 is a diagram illustrating a filter calculating unit of a QME data processing unit in accordance with an embodiment of the present invention.

The FIR filter 203 includes four sub-modules, such as a horizontal filtering unit femc_hfilter 810, a first vertical filtering unit fmemc_vfilter×8 820, a second vertical filtering unit fmemc_vfilter×15 830, and a data arrangement logics 840.

The vertical filtering unit 810 performs 6-tab FIR filtering in a vertical direction on the previous picture data of a 64 bit size, that is, the search area data PI [63:0].

The first vertical direction filtering unit 820 performs the 6-tab FIR filtering in a vertical direction on a first output data hfilter_po [63:0] of a horizontal filtering unit 810 when the motion in the horizontal direction is integer component and the second vertical filtering unit 830 performs the 6-tab FIR filtering in the vertical direction on a second output data hfilter_po_fu [119:0] of the vertical filtering unit 810 when the motion in the horizontal direction is the ½ pixel component.

The data arrangement logics 840 performs data arrangement on 80 bit data POV [79:0] output from the first vertical filtering unit 820 and 72 bit data POD [71:0] and POH [71:0] output from the second vertical filtering unit 830 to output FIR filtered search area data PE0 [63:0] to PE8 [63:0] of a 64 bit size that are input from the nine processing elements, respectively.

A data synchronization unit fmemc_cm_buf 850 synchronizes data DIN [63:0] for the current macroblocks with the FIR filtered search region data. That is, the nine current picture data CI0 [63:0] to CI8 [63:0] are output.

As such, when the data filtered in the horizontal, vertical, horizontal/vertical direction and the current macroblock data are secured, the FIR filter 203 effectively arranges the data to be arranged in a form suitable for the SAD calculation and transmits the arranged data to each processing element 410.

For the vertical filtering, six pixels neighboring to each other in a vertical direction needs to be secured. To this end, a shift register 900 is input with data PI [63:0] at an integer position from the vertical filtering unit 810 for 3 cycles (16×16 or 16×8 mode) or 2 cycles (8×16 or 8×8 mode). For the most significant bit, valid data corresponding to 8-8-2 (16×16 or 16×8 mode) or 8-2 (8×16 or 8×8 mode) are provided.

The shift register 900 are configured by sequentially connecting a plurality of D-flip flops with each other and stores the data input from the horizontal filtering unit 810 to output all the data P00 [63:0] to P05 [63:0] corresponding to 6 lines. Data enable signals indicating that all the output data corresponding to 6 lines are valid are output so as to perform the 6-tab FIR filtering.

17 (16×16 or 16×8 mode) or 9 (8×16 or 8×8 mode) data filtered in a horizontal direction are output and therefore, even though the data are represented by 64 bit data, since the data enable signals are generated for 3 cycles (16×16 or 16×8 mode) or 2 cycles (8×16 or 8×8 mode), the shift register 900 has a form in which 15 (16×16 or 16×8 mode) or 10 (8×16 or 8×8 mode) 64 bit registers are connected and a chain length of the shift register 900 is determined by an IMODE signal.

The fine motion estimation device in accordance with the embodiment of the present invention adopts the small hardware architecture to save hardware resource about 50% as compared with the existing methods and thus, reduce the power consumption about 50%.

In addition, the motion estimation is performed in a range between −0.75 and +0.75 in the horizontal/vertical directions and the motion compensation data for the luminance component is generated.

The embodiment of the present invention supports four operation modes. The number of processing cycles consumed per a macroblock in each operation mode is as follows. Since 178 cycles are consumed at the time of simulation of the 16×16 mode, 182 cycles are consumed at the time of simulation of the 16×8 mode, 202 cycles are consumed at the time of simulation of the 8×16 mode, and 246 cycles are consumed at the time of simulation of the 8×8 mode, the picture having the Full HD (1920×1080) resolution can be processed in real time.

The embodiment of the present invention can reduce the hardware area without degrading performance by configuring the architecture in which various modes can be processed in parallel and implementing the various modes using the single hardware, in the fine motion estimation method for the motion estimation block having the most calculations among the component blocks of H.264.

Further, the embodiment of the present invention can perform the fine (¼ pixel unit) motion estimation having the Full HD resolution using the single hardware for four modes of 16×16, 8×16, 16×8, and 8×8 and the high-performance motion estimation using the small hardware resource.

In addition, the embodiment of the present invention can reduce the hardware about 50% as compared with the existing methods and obtain a gain of about 50% in terms of the power consumption.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

What is claimed is:

1. A fine motion estimation device for high resolution, comprising:
a previous picture storage memory configured to store search area data of previous pictures for macroblocks of current pictures;
an FIR filter configured to perform FIR filtering on the search area data stored in the previous picture storage memory;
a memory configured to differentiate and store the FIR filtered search area data according to operating modes;
a QME data processing unit configured to generate reference area data for motion estimation in a ¼ pixel unit by using the FIR filtered search area data stored in the memory;
a processing array unit configured to perform motion estimation in a ½ pixel unit using the FIR filtered search area data and the macroblocks transmitted from the FIR filter and to perform motion estimation in the ¼ pixel unit using the reference area data based on a ½ pixel motion vector according to the motion estimation in the ½ pixel unit; and
a control unit configured to control an operation of the FIR filter, the processing array unit, and the QME data processing unit.

2. The fine motion estimation device of claim 1, wherein the processing array unit searches the ½ pixel motion vector and the ¼ pixel motion vector according to the motion estimation in the ¼ pixel unit by calculating sum of absolute differences (SADs).

3. The fine motion estimation device of claim 2, wherein the processing array unit includes:
nine processing elements configured to calculate SAD values with one of the current picture macroblock data, the reference picture data, and the search area data; and
an SAD determining unit configured to output a minimum value among the SAD valued output from the plurality of processing elements and positions corresponding thereto.

4. The fine motion estimation device of claim 1, wherein the FIR filter includes:
a horizontal filtering unit configured to perform 6-tab FIR filtering in a horizontal direction on the search picture data;
a first vertical filtering unit configured to perform the 6-tab FIR filtering in a vertical direction on a first output value having a 64 bit size of the horizontal filtering unit when a motion in a horizontal direction is integer component;
a second vertical filtering unit configured to perform the 6-tab FIR filtering in a vertical direction on a second output value having a 120 bit size of the horizontal filtering unit when a motion in a horizontal direction is ½ pixel component; and
data arrangement logics configured to perform data arrangement on an output value of the first vertical filtering unit and an output value of the second vertical filtering unit.

5. The fine motion estimation device of claim 4, further comprising:
a data synchronization unit configured to synchronize the macroblocks of the current pictures with the FIR filtered search area data.

6. The fine motion estimation device of claim 1, wherein when the macroblocks of the current pictures are 16×16, a size of the search area of the previous pictures is 64×48.

7. The fine motion estimation device of claim 6, wherein the operating modes are at least one of a 16×16 mode, a 16×8 mode, an 8×16 mode, and an 8×8 mode.

8. The fine motion estimation device of claim 1, wherein the memory is configured of four SRAMs having parallel architecture.

9. The fine motion estimation device of claim 1, wherein the QME data processing unit is a motion estimation processing unit in the ¼ pixel unit that processes data for motion estimation in the ¼ pixel unit.
